(19) United States
(12) Patent Application Publication
(10) Pub. No.: US 2013/0159884 A1
(43) Pub. Date: Jun. 20, 2013

(54) INFORMATION PROCESSING APPARATUS, INFORMATION PROCESSING METHOD, AND PROGRAM

(71) Applicants: Masaaki Isozu, Tokyo (JP); Kazuhiro Watanabe, Tokyo (JP)

(72) Inventors: Masaaki Isozu, Tokyo (JP); Kazuhiro Watanabe, Tokyo (JP)

(73) Assignee: Sony Corporation, Tokyo (JP)

(21) Appl. No.: 13/614,345

(22) Filed: Sep. 13, 2012

(30) Foreign Application Priority Data
Dec. 20, 2011 (JP) 2011-277863

(51) Int. Cl. G06F 3/01; G06F 15/16

(52) U.S. Cl. 715/753

(57) ABSTRACT

An information processing apparatus may include at least one communication interface configured to receive notification of one or more other apparatuses in proximity to the apparatus; and at least one processor configured to, in response to the notification and based at least in part on a calculated sharing recommendation degree, cause at least one display to display a prompt to share content with at least one of the other apparatuses. An information processing method may include determining that one or more other apparatuses are in proximity to a first apparatus; calculating a sharing recommendation degree; and in response to determining that the one or more other apparatuses are in proximity to the first apparatus, and based at least in part on the calculated sharing recommendation degree, displaying on a display of the first apparatus a prompt to share content with at least one of the other apparatuses.

### CROSS REFERENCE TO RELATED APPLICATION

This application claims the benefit of priority under 35 U.S.C. §119 to Japanese Priority Patent Application JP 2011-277863 filed in the Japan Patent Office on Dec. 20, 2011, the entire contents of which are hereby incorporated by reference.

### BACKGROUND

The present disclosure relates to an information processing apparatus connectable to a network, and to an information processing method and a program for the information processing apparatus.

In recent years, almost all information devices have network connection functions, which has allowed information devices located at close positions to exchange content with each other. For example, in the case where a user of a certain information device wants to transmit content therein to (an information device of) a nearby friend, the user employs a procedure of searching for a nearby information device by using a wireless communication function implemented in the information device, causing the information device to display a user list, and selecting a name of the friend therefrom to transmit and share content to and with the friend. Such a technique is convenient when specific content is exchanged with friends. However, to exchange a plurality of content items with an unspecified number of friends, the procedure may become complicated.

In addition, in performing an operation of searching for an information device of a nearby user and exchanging content with that information device if the information device is found, in the case where an information device of another user that can exchange content is not present near the user, the procedure of “searching” comes to nothing.

For example, Japanese Patent Application Laid-open No. 2006-285359 (hereinafter, referred to as Patent Document 1) is a document related to content exchange (sharing). Patent Document 1 discloses the following technique. If a certain terminal (terminal A) has data, but another terminal (terminal B) does not the data among a plurality of terminals, recommendation information is provided to a user of the terminal A and prompts the user to provide the data to the terminal B.

### SUMMARY

In the technique disclosed in Patent Document 1, recommendation for sharing on the basis of content can be performed. In the technique, however, which user has which content or which user does not have content is necessary to be determined, which leads to complicated processing.

In view of the circumstances as described above, it is desirable to provide an information processing apparatus, an information processing method, and a program that allow content to be shared with another device.

Accordingly, one type of embodiment is directed to apparatus comprising: at least one communication interface configured to receive notification of one or more other apparatuses in proximity to the apparatus; and at least one processor configured to, in response to the notification of the one or more other apparatuses in proximity to the apparatus, and based at least in part on a calculated sharing recommendation degree, cause at least one display to display a prompt to share content with at least one of the one or more other apparatuses.

Another type of embodiment is directed to a method comprising: determining that one or more other apparatuses are in proximity to a first apparatus; calculating a sharing recommendation degree; and in response to determining that the one or more other apparatuses are in proximity to the first apparatus, and based at least in part on the calculated sharing recommendation degree, displaying on a display of the first apparatus a prompt to share content with at least one of the one or more other apparatuses.

Another type of embodiment is directed to at least one computer-readable storage medium encoded with computer-executable instructions that, when executed, perform a method comprising: determining that one or more other apparatuses are in proximity to a first apparatus; calculating a sharing recommendation degree; and in response to determining that the one or more other apparatuses are in proximity to the first apparatus, and based at least in part on the calculated sharing recommendation degree, displaying on a display of the first apparatus a prompt to share content with at least one of the one or more other apparatuses.

### BRIEF DESCRIPTION OF DRAWINGS

FIG. 1 is a block diagram showing a hardware configuration of a portable terminal according to an embodiment of the present disclosure;

FIG. 2 is a flowchart showing a basic operation flow of the portable terminal according to the embodiment of the present disclosure;

FIG. 3 is a diagram showing a state in which a sharing start button is displayed on a display in the embodiment of the present disclosure;

FIG. 4 is a diagram showing an example of the display in the case where the portable terminal receives photographs from other adjacent devices in the embodiment of the present disclosure;

FIG. 5 is a diagram showing a shared state of photographs among a plurality of devices including the portable terminal according to the embodiment of the present disclosure in a time-series manner;

FIG. 6 are diagrams each showing another example of the sharing start button displayed on the display in the embodiment of the present disclosure;

FIG. 7 is a diagram conceptually showing a relationship among the number of other adjacent users, the number of photographs taken with the other devices, and a size of the sharing start button;

FIG. 8 is a flowchart showing another displaying processing flow in the case where the portable terminal receives a photograph from another adjacent device in the embodiment of the present disclosure;

FIG. 9 is a diagram showing another example of the display in the case where the portable terminal receives photographs from other adjacent devices in the embodiment of the present disclosure;

FIG. 10 is a flowchart showing a processing flow of the portable terminal in the case where the number of sharable photographs is limited in the embodiment of the present disclosure; and

FIG. 11 is a flowchart showing another display processing flow of the sharing start button in the embodiment of the present disclosure.

### DETAILED DESCRIPTION OF EMBODIMENTS

Hereinafter, an embodiment of the present disclosure will be described with reference to the drawings.

[Hardware Configuration of Portable Terminal]

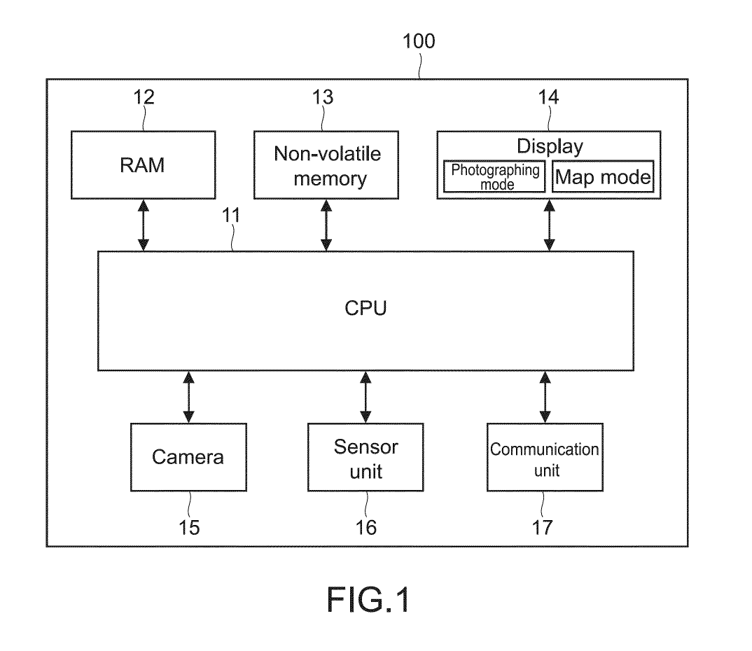

FIG. 1 is a block diagram showing a hardware configuration of a portable terminal according to an embodiment of the present disclosure. Here, the portable terminal refers to an information processing apparatus including a casing capable of being held by a user, such as, specifically, a smartphone, a mobile phone, a tablet PC (Personal Computer), a PDA (Personal Digital Assistant), a portable AV (Audio-Visual) player, an electronic book, or a digital still camera.

As shown in FIG. 1, this portable terminal 100 includes at least one processor such as a CPU (Central Processing Unit) 11, a RAM (Random Access Memory) 12, a non-volatile memory 13, at least one display 14, a camera 15, a sensor unit 16, and at least one communication interface such as a communication unit 17.

The CPU 11 accesses the RAM 12 and the like when necessary and performs overall control on blocks of the portable terminal 100 while performing various types of computation processing. The RAM 12 is used as a work area and the like of the CPU 11 and temporarily stores an OS, various applications in execution, and various pieces of data being processed (photographic data, map data, and the like to be described later).

The non-volatile memory 13 is, for example, a flash memory or a ROM (Read Only Memory) and fixedly stores the OS to be executed by the CPU 11 and firmware including programs (applications), various parameters, and the like.

Further, the non-volatile memory 13 stores still-image data (photographic data) and moving-image data that are captured by the camera 15 or received from another device via the communication unit 17. The photographic data is stored with metadata such as data indicating a date and time of the photographing, position data (latitude/longitude data) indicating a photographing position, and data indicating climatic conditions at the photographing (temperature, humidity, atmospheric pressure, etc.) being added to the photographic data.

The display 14 is, for example, an LCD (Liquid Crystal Display) or an OELD (Organic Electroluminescence Display) and displays GUIs and the like of various menus and applications. Typically, the display 14 is integrated with a touch panel and can receive a touch operation from a user.

In this embodiment, using the display 14, the CPU 11 can execute at least a photographing mode capable of taking photographs with the camera 15 and a map mode capable of displaying map data in which taken photographs, received photographs, and the like are arranged. The display 14 displays an image of an electronic viewfinder or a taken photograph in the photographing mode, and displays a map in the map mode, thus switching display according to the modes. In addition, the CPU 11 can also execute a reproduction mode in which a taken photograph and moving image are reproduced. Further, in this embodiment, the CPU 11 can execute a photo-sharing mode for, during the execution of the photographing mode, releasing (transmitting) a taken photograph to another portable terminal or receiving a photograph from another portable terminal.

The camera 15 captures a still image (photograph) and a moving image with use of an imaging device such as a CMOS (Complementary Metal Oxide Semiconductor) or a CCD (Charge Coupled Device) sensor.

The sensor unit 16 is constituted of various sensors and detects position information (latitude and longitude information) and physical information (acceleration and gravity) of the portable terminal 100, a position of a finger of a user holding the portable terminal 100, and the like. The position information is detected with a GPS (Global Positioning System) sensor, for example. Further, the position information may be detected by performing trilateration with a base station by wireless communication of the communication unit 17. The physical information is detected with an angular velocity (gyro) sensor or an acceleration sensor. Further, the camera 15 and the touch panel described above are also kinds of sensors. The position of the finger of the user is detected with, for example, a touch panel, a proximity sensor, a pressure-sensitive sensor, an illumination sensor, the camera 15, and the like.

The portable terminal 100 may also include, for example, a geomagnetic sensor that detects a direction (orientation) in which the portable terminal 100 faces.

The communication unit 17 uses a wireless LAN (Local Area Network) (IEEE 802.11 etc.) such as WiFi (Wireless Fidelity) or a 3G or 4G network for mobile communication, to communicate with other adjacent portable terminals. The communication unit 17 is used for transmitting and receiving (sharing) content such as photographic data or transmitting and receiving other data, for example.

[Software Configuration of Portable Terminal]

Though not shown in the figures, the portable terminal 100 includes, as software used in the processing of this embodiment, a connection device management module, a content transmission and reception module, a sharing start module, and the like. Those software modules are stored in the non-volatile memory 13.

Using the communication unit 17, the connection device management module determines whether another device communicable by wireless communication is present in the vicinity of the portable terminal 100 and manages a result of the determination. Specifically, the connection device management module regularly determines whether a communicable device is present in the vicinity of the portable terminal 100 during a period of time in which the portable terminal 100 is executing the photographing mode.

Whether another device is present in the vicinity is determined based on the reach of wireless communication, for example. Specifically, the connection device management module wirelessly broadcasts an investigation message to a surrounding area at regular intervals during a period of time in which, for example, the portable terminal 100 is executing the photographing mode. If a device that has received the message is also executing the photographing mode, the device returns a response indicating that it is executing the photographing mode. One or more communication interfaces of portable terminal 100 may receive the response as notification that the other device is in proximity to portable terminal 100.

Further, as another method, all devices including the portable terminal 100 are preset so as to wirelessly broadcast notification messages at regular intervals during the execution of the photographing mode, the notification messages indicating that those devices are executing the photographing mode. The connection device management module may determine the presence of other devices in proximity to portable terminal 100 by receiving the notification messages.

As still another method, position information of devices including the portable terminal 100 may be collected by a server on the Internet (cloud) side, and when a device in execution of the photographing mode contacts the server, the server may return position information of a device that is present in the vicinity of the server. The connection device management module uses the position information and position information of the portable terminal 100 acquired by the sensor unit 16 to calculate a distant relationship and then determines whether devices are present in the vicinity.

Further, the connection device management module also investigates the number of content items (e.g., content files) such as photographs taken (stored) by adjacent devices. This investigation is achieved similarly to the method of investigating the presence of another device. In other words, the connection device management module may wirelessly broadcast an inquiry message for the number of content items to a surrounding area at regular intervals, and determine the number of content items based on a result of responses thereto. Further, each device may be preset so as to wirelessly broadcast a notification message for regular notification of the number of content items taken (stored) by each device, and the connection device management module may determine the number of content items based on the notification message. Additionally, the server on the cloud may collect information on the number of content items taken by each device, and the connection device management module may contact the server.

The content transmission and reception module uses the communication unit 17 to transmit and receive content such as photographs to and from a device in the vicinity. At that time, the content transmission and reception module appropriately controls the number of content items to be transmitted or received.

The sharing start module takes into account a position of another adjacent device, the number of content items taken (stored) by another device, and the like, which have been acquired by the above-mentioned modules, and determines whether to display a prompt such as a sharing start button, which will be described later, on the display 14.

[Operation of Portable Terminal]

Next, operations of the portable terminal 100 configured as described above will be described. In the following description, the CPU 11 of the portable terminal 100 will be described as a main subject of the operations, but those operations are also performed in cooperation with programs executed under the control of the CPU 11.

(Basic Operation)

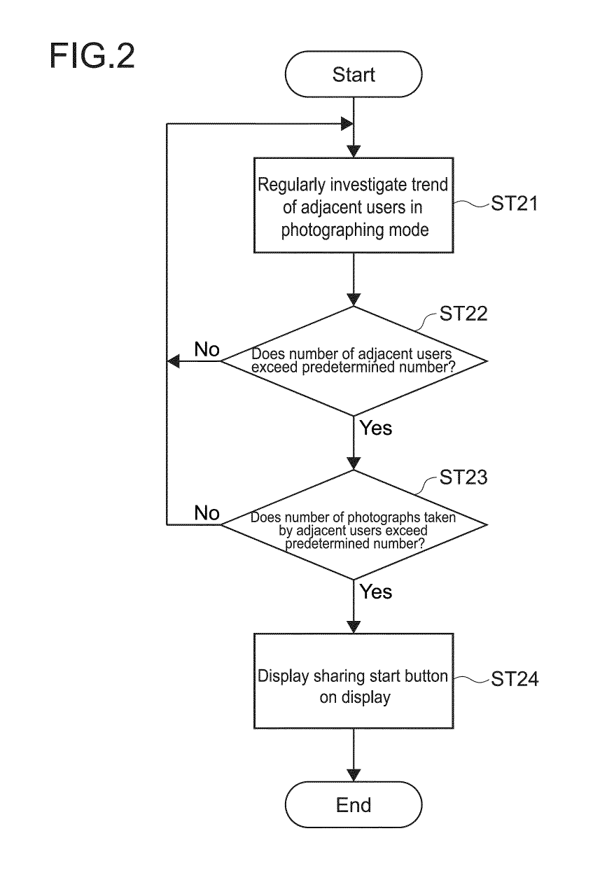

A basic operation flow of the portable terminal 100 in this embodiment will first be described. FIG. 2 is a flowchart showing the operation flow.

As shown in FIG. 2, first, the CPU 11 of the portable terminal 100 regularly investigates a trend of adjacent users (other adjacent devices), i.e., the number of other devices and the number of photographs taken by the other devices, in the photographing mode and by the above-mentioned methods (Step 21).

Subsequently, the CPU 11 determines whether the number of other adjacent devices exceeds a predetermined number (Step 22). Here, the predetermined number is, for example, three or five, but it is not limited thereto.

When determining that the number of other devices exceeds the predetermined number (Yes), the CPU 11 determines whether the number of shareable content files such as photographs taken by the adjacent devices exceeds a predetermined number of photographs (Step 23). Here, the predetermined number is, for example, five or ten in total of the devices, but it is not limited thereto.

Then, when determining the number of photographs exceeds the predetermined number (Yes), the CPU 11 generates a prompt such as a sharing start button and displays the button on the display 14 (Step 24). Thus, in some embodiments, the one or more processors of portable terminal 100 may be configured to, in response to notification of one or more other apparatuses in proximity to portable terminal 100, and based at least in part on a calculated sharing recommendation degree, cause the one or more displays of portable terminal 100 to display a prompt to share content with one or more of the other apparatuses. In some embodiments, the sharing recommendation degree may be calculated based at least in part on the number of other apparatuses in proximity to portable terminal 100. Alternatively or additionally, the sharing recommendation degree may be calculated based at least in part on the number of shareable content files (e.g., photographs) available from the other apparatuses. In some embodiments, the prompt may include a selectable graphical object, an example of which may be a button such as a sharing start button. In some embodiments, the user may input an affirmative response to the prompt (e.g., indicating that the user would like to share content) by selecting the selectable graphical object such as the sharing start button.

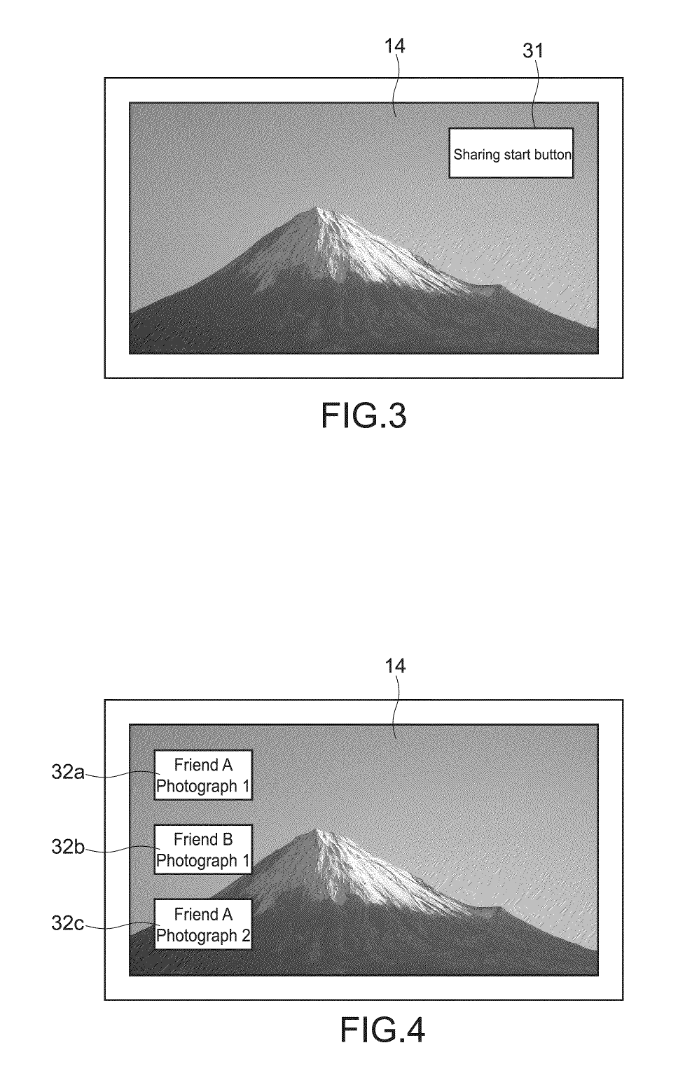

FIG. 3 is a diagram showing an example of a state in which a sharing start button is displayed on the display 14.

As shown in FIG. 3, while the user is taking photographs of a landscape etc. in the photographing mode by viewing an electronic viewfinder displayed on the display 14, when the number of other adjacent devices exceeds the predetermined number and the number of photographs taken by those devices exceeds the predetermined number, a sharing start button 31 is displayed as a GUI (graphical user interface) on the display 14. A display position of the sharing start button 31 is located at, for example, a corner of the display 14 so as not to hinder photographing by the user in the electronic viewfinder.

In some embodiments, the one or more processors of portable terminal 100 may be configured to cause the one or more communication interfaces of portable terminal 100 to share content with one or more of the other apparatuses in proximity to portable terminal 100, in response to the user inputting an affirmative response to the prompt. For example, when the user presses (touches) the sharing start button 31, the portable terminal 100 may transfer to a sharing mode. Specifically, the portable terminal 100 enters a state in which photographs taken by the portable terminal 100 and stored in, for example, the non-volatile memory 13 thereof can be released (transmitted) to other adjacent devices, and photographs taken by those other adjacent devices and then stored therein can be received. Whether photographs are actually transmitted and received depends on a pressed status of the sharing start button 31 of each adjacent device, which will be described later in detail.

Further, when the sharing start button 31 is pressed, the portable terminal 100 deletes the sharing start button 31 from the display 14 immediately after the press. Accordingly, an improper operation of the user is prevented, and the photographing on the electronic viewfinder is not hindered.

FIG. 4 is a diagram showing an example of the display 14 in the case where the portable terminal 100 receives photographs from other adjacent devices in the sharing mode after the sharing start button 31 is pressed.

As shown in FIG. 4, when the portable terminal 100 receives photographs from other devices (for example, from portable terminals of friends) in the sharing mode, the portable terminal 100 displays those photographs 32 (32a to 32c) on the electronic viewfinder displayed on the display 14. As illustrated in FIG. 4, in some embodiments, the content received from other apparatuses may be displayed concurrently with content created by the user of portable terminal 100 (e.g., the user's own photograph taken via portable terminal 100). In some embodiments, the received content may be displayed superimposed on the content created by the user. Display positions of the photographs 32 are located at, for example, a corner of the display 14 so as not to hinder the photographing by the user, as in the case of the sharing start button 31. Every time the portable terminal 100 receives photographs, the photographs 32 are sequentially displayed on the display 14. Those photographs 32 may be deleted when a certain period of time elapses after being displayed.

The other adjacent devices of the portable terminal 100 are not limited to devices of friends of the user of the portable terminal 100. Photographs may be transmitted from devices of users who are not personally known by and happen to be around the user of the portable terminal 100.

Here, the photographs 32 to be shared and displayed may not be the captured photographic data and may be thumbnails. In this case, when the user views thumbnails received on the display 14 and then likes some thumbnails, the user may acquire them by requesting a device as a transmission source of the thumbnails to transmit actual data anew or accessing a server, a service (SNS (Social Network Service) etc.), and the like to which the device has uploaded the actual data.

Further, metadata such as a user name, a file name, and the like, which are added to the displayed photographs 32, may be displayed together with the displayed photographs 32.

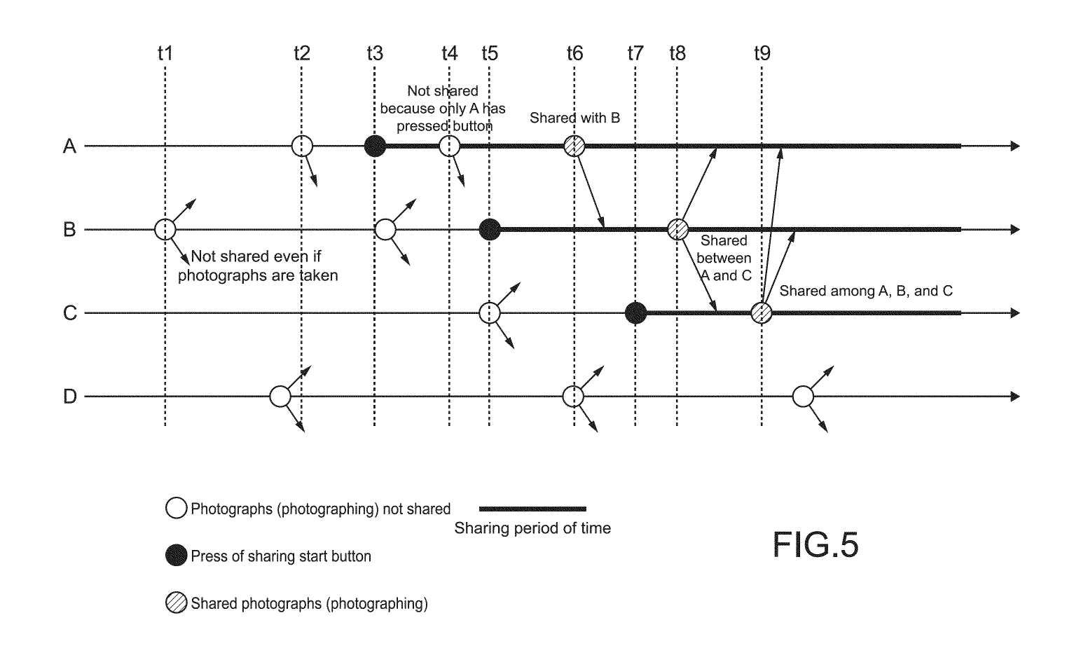

FIG. 5 is a diagram showing a shared state of photographs among a plurality of devices including the portable terminal 100 in a time-series manner.

FIG. 5 shows a state in which four devices A, B, C, and D that are located adjacently to one another (including the portable terminal 100) share photographs. It is assumed that each of the devices has a photo-sharing function as in the portable terminal 100 described above. In FIG. 5, an open circle on a time axis represents a photographing event of photographs that are not to be shared, a filled circle on a time axis represents a pressing event of the sharing start button 31, and a circle with hatched lines represents a photographing event of photographs that are to be shared. In addition, a thick part of the time axis represents a period during which photographs are shared.

As shown in FIG. 5, it is assumed that a user of the device B takes a photograph at time t1. In this case, however, none of users of the devices has pressed the sharing start button 31, and the photograph is not transmitted or received in this state. Therefore, the photograph taken with the device B is not shared with (transmitted to) the other devices. The same holds true for operation performed at time t2.

Subsequently, it is assumed that the user of the device A presses the sharing start button 31 at time t3 so that the device A transfers to the sharing mode, and thereafter the user takes a photograph at time t4. At this time point, however, the users of the other devices have not pressed the sharing start button 31. Therefore, the photograph taken with the device A is allowed to be transmitted in this state, but it is not shared with (transmitted to) the other devices.

Subsequently, it is assumed that the user of the device B presses the sharing start button 31 at time t5 so that the device B transfers to the sharing mode. After that, in the case where the user of the device A takes a photograph at time t6, the photograph is shared with (transmitted to) the device B in the sharing mode. For example, in some embodiments, the one or more processors of portable terminal 100 may be configured to cause the one or more communication interfaces of portable terminal 100 to share content in response to a determination that one or more of the other apparatuses in proximity to portable terminal 100 are in sharing mode. On the other hand, the photograph is not transmitted to the devices C and D that have not transferred to the sharing mode.

Subsequently, it is assumed that the user of the device C presses the sharing start button 31 at time t7 so that the device C transfers to the sharing mode. After that, in the case where the user of the device B takes a photograph at time t8, the photograph is shared with (transmitted to) the devices A and B that are in the sharing mode at that time point. On the other hand, the photograph is not transmitted to the device D that has not yet transferred to the sharing mode.

Subsequently, in the case where the user of the device C takes a photograph at time t9, the photograph is shared with (transmitted to) the devices A and B that are in the sharing mode. On the other hand, the photograph is not transmitted to the device D that has not yet transferred to the sharing mode.

As described above, when the user of each device presses the sharing start button 31, the device enters a state in which photographs are sharable (allowed to be transmitted and received). Then, when the users of devices adjacent thereto also press the sharing start button 31, photographs are actually shared (transmitted and received). In other words, the user can transmit own photographs to other users and receive photographs from other users by merely pressing the sharing start button 31. This is based on the idea that a user releases own photographs if the user wants photographs of others. Furthermore, in some embodiments, content created by the user after inputting the affirmative response to the prompt may be transmitted for access by one or more other apparatuses in proximity to portable terminal 100, and content created by the user before inputting the affirmative response may not be transmitted.

(Display Form of Sharing Start Button)

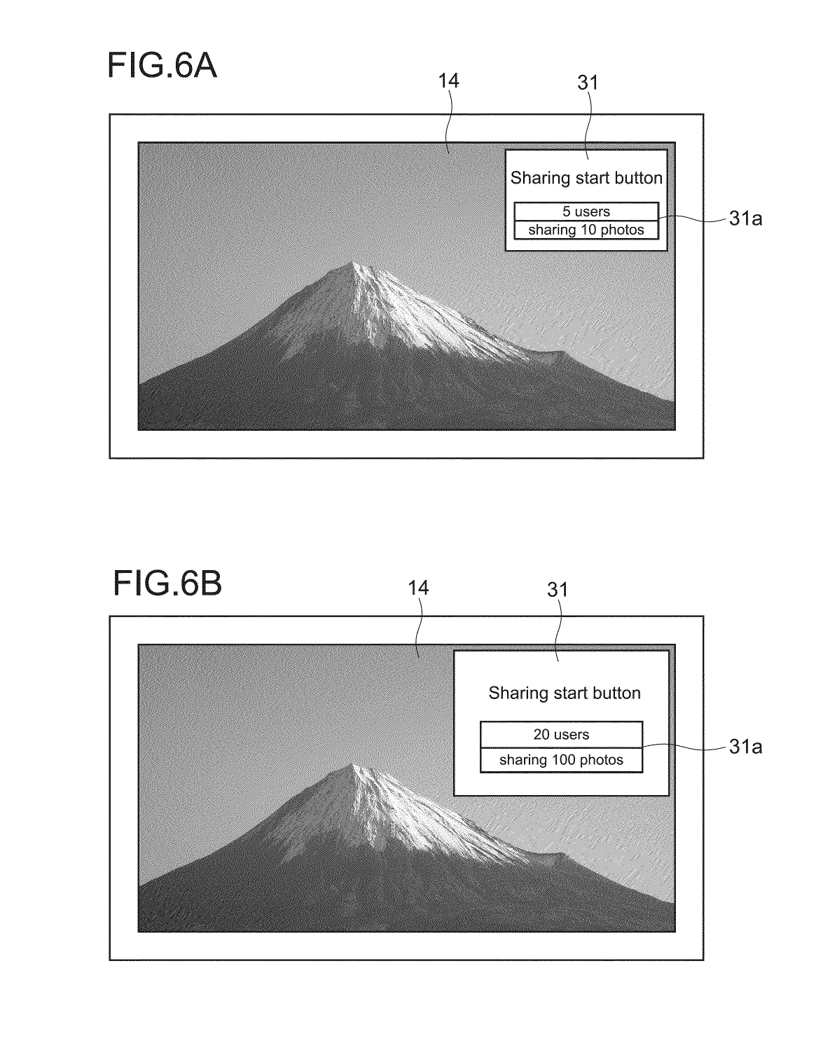

The display form of the sharing start button 31 is not limited to the one displayed in FIG. 3. In some embodiments, the one or more processors of portable terminal 100 may be configured to limit the number of content files shared with other apparatuses in proximity to portable terminal 100. For example, the size of the sharing start button 31 may be changed in accordance with the number of other adjacent devices (users) with which communication is established and the number of photographs taken with those other adjacent devices. FIGS. 6A and 6B are diagrams each showing a display example of the sharing start button 31 in such a case.

FIG. 6A is a display example of the sharing start button 31 in the case where the number of adjacent users and the number of photographs are relatively small, and FIG. 6B is a display example of the sharing start button 31 in the case where those numbers are relatively large.

As shown in FIGS. 6A and 6B, the sharing start button 31 displayed when the number of adjacent users and the number of photographs of the users are large (for example, the number of users is 20, the number of photographs is 100) is larger in size than the sharing start button 31 displayed when those numbers are small (for example, the number of users is 5, the number of photographs is 10).

Further, in the sharing start button 31, a number 31a of users and photographs may be clearly expressed. As illustrated by this example, in some embodiments, the prompt to share content may include an indication of the calculated sharing recommendation degree. In some embodiments, such an indication may include the number of other apparatuses in proximity to portable terminal 100, and/or the number of shareable content files available from the other apparatuses.

With such a display form, the user can visually determine the number of adjacent users and the number of receivable photographs based on the size of the sharing start button 31, which becomes a motivation for pressing the sharing start button 31. The sharing start button 31 largely displayed is considered to be in a state of strongly recommending sharing of the photographs.

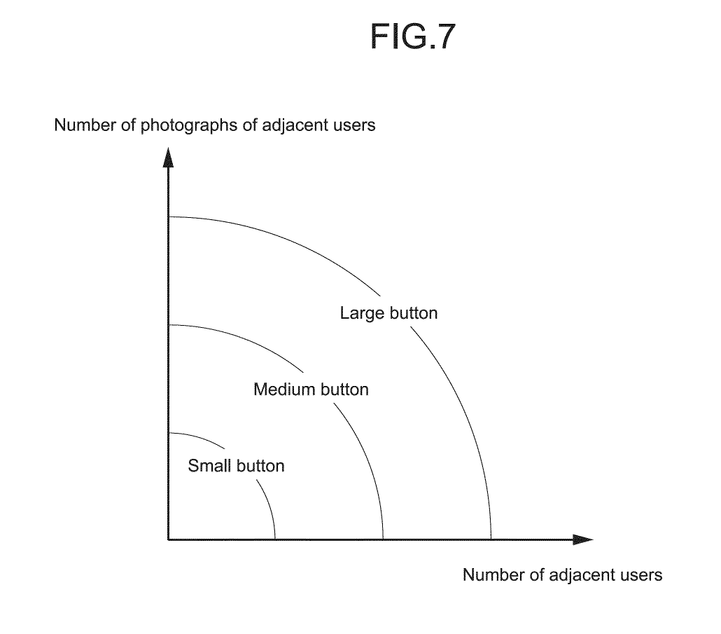

FIG. 7 is a diagram conceptually showing a relationship among the number of other adjacent users (devices), the number of photographs taken with the other devices, and the size of the sharing start button 31. As shown in FIG. 7, as the number of adjacent users and the number of photographs taken with other devices become larger, the size of the sharing start button 31 to be displayed becomes larger.

(Display Form of Received Photograph)

The display form of content such as photographs received after the press of the sharing start button 31 is also not limited to the one shown in FIG. 4. In some embodiments, the one or more processors of portable terminal 100 may be configured to specify a position on the one or more displays of portable terminal 100 at which to display the received content, based at least in part on the location at which the received content was created. For example, a display position of a photograph (thumbnail) may be changed in accordance with data of a photographing position added to the received photograph.

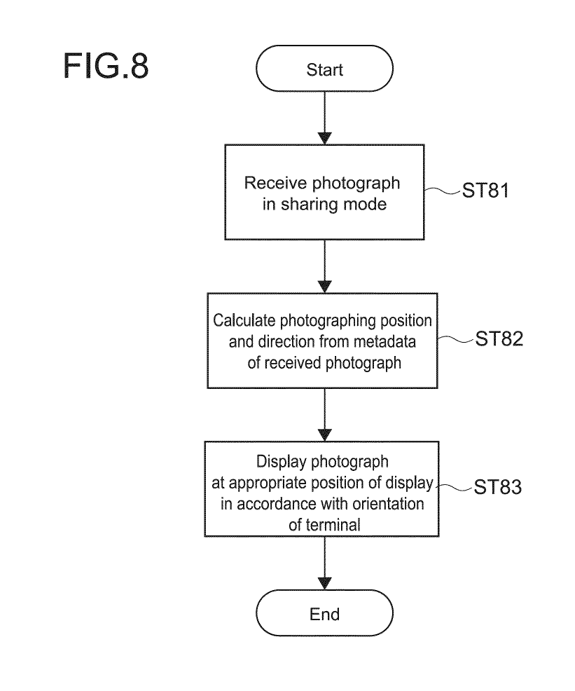

FIG. 8 is a flowchart showing a displaying processing flow of a photograph in such a case.

As shown in FIG. 8, the CPU 11 of the portable terminal 100 first receives a photograph from another device during a execution of the sharing mode (Step 81). Metadata such as position information indicating a photographing position of the photograph is added to the photograph.

Subsequently, the CPU 11 calculates a photographing position (latitude and longitude) based on the metadata of the received photograph and then its direction viewed from a current position of the portable terminal 100 (Step 82). Further, the CPU 11 calculates a distance from the current position of the portable terminal 100 to the photographing position of the received photograph.

Then, the CPU 11 arranges the photograph at an appropriate position of the display 14 for display, based on the calculated photographing position and distance according to the orientation of the portable terminal 100 (Step 83). In this case, the photograph is displayed at a position, of the display 14, corresponding to the photographing position and in the size corresponding to the calculated distance.

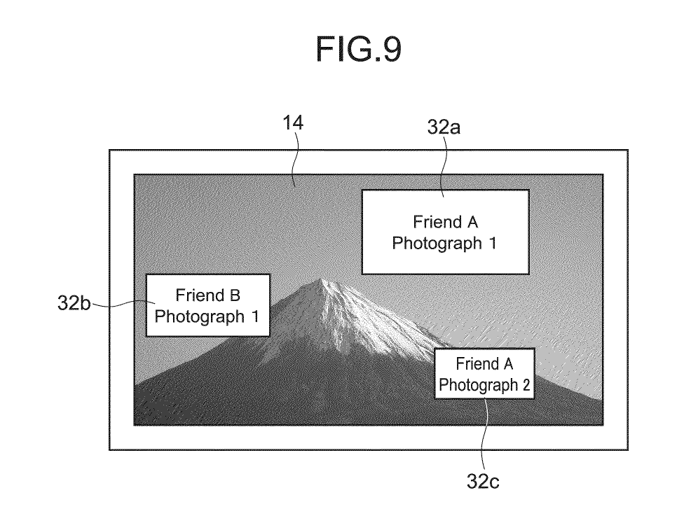

FIG. 9 is a diagram showing an example of photographs displayed by the processing described above. FIG. 9 shows an example in which the current position of the portable terminal 100 is set at a lower center of the display 14, and photographing positions of photographs taken before the portable terminal 100 are obtained in a bird's eye view.

As shown in FIG. 9, out of three received photographs, a photograph 32a received from a device of a friend A is displayed in a large size on a diagonally forward right of the user of the portable terminal 100. Similarly, a photographs 32c received from the device of the friend A is displayed in a slightly small size at a position lower than the photographs 32a. Accordingly, the user of the portable terminal 100 can visually grasp that the friend A has taken the photograph 32a at the diagonally forward right position of the user and the photographs 32c at a position closer to the right-hand side viewed from the user and farther from the user. In the same manner, the user can grasp that a friend B has taken a photograph 32b on the left-hand side of the user.

As a matter of course, the position of the portable terminal 100 may be determined at the center of the display 14 so that photographs taken in all directions viewed from the portable terminal 100 may be displayed.

(Limit on Number of Sharable Photographs)

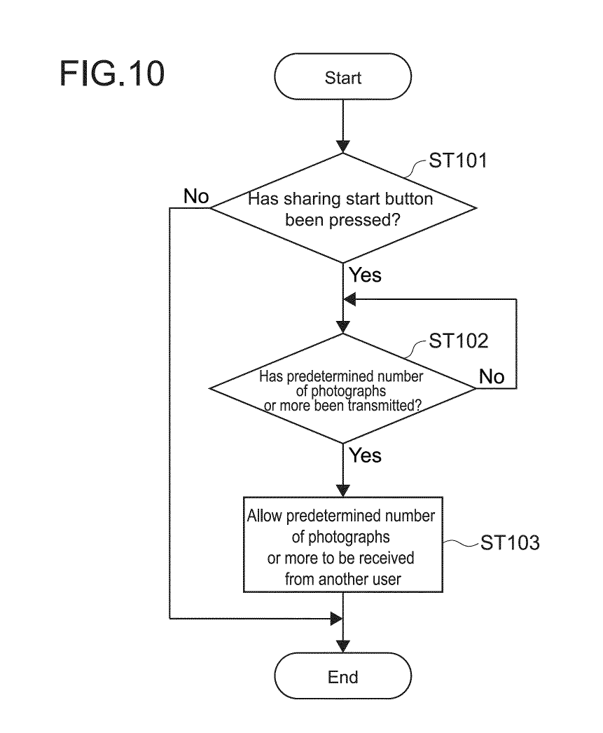

In the example described above, in the case where the sharing start button 31 of the portable terminal 100 is pressed and a sharing start button 31 of another device is also pressed, all photographs taken with the portable terminal 100 are shared. However, the number of sharable content files such as photographs may be limited. FIG. 10 is a flowchart showing a processing flow of sharing photographs by the portable terminal 100 in this case.

As shown in FIG. 10, the CPU 11 first determines whether the sharing start button 31 has been pressed (Step 101).

When determining that the sharing start button 31 has been pressed (Yes), the CPU 11 determines whether a predetermined number of photographs or more taken with the portable terminal 100 has been transmitted to another device (Step 102). The predetermined number refers to, for example, 10 or 20, but it is not limited thereto.

When determining that a predetermined number of photographs or more has been transmitted (Yes), the CPU 11 allows the predetermined number of photographs to be received form the other device (Step 103). Specifically, in the case where a device in the sharing mode transmits photographs to the portable terminal 100, the CPU 11 receives the photographs until the number of photographs reaches the predetermined number. However, the CPU 11 refuses to receive the photographs any more if the number of photographs exceeds the predetermined number.

By such processing, the user of the portable terminal 100 does not improperly transmit many photographs to other devices. Conversely, the user of the portable terminal 100 does not receive many more photographs than the photographs taken by his/herself.

(Display Processing of Sharing Start Button in Accordance with Finger Position of User)

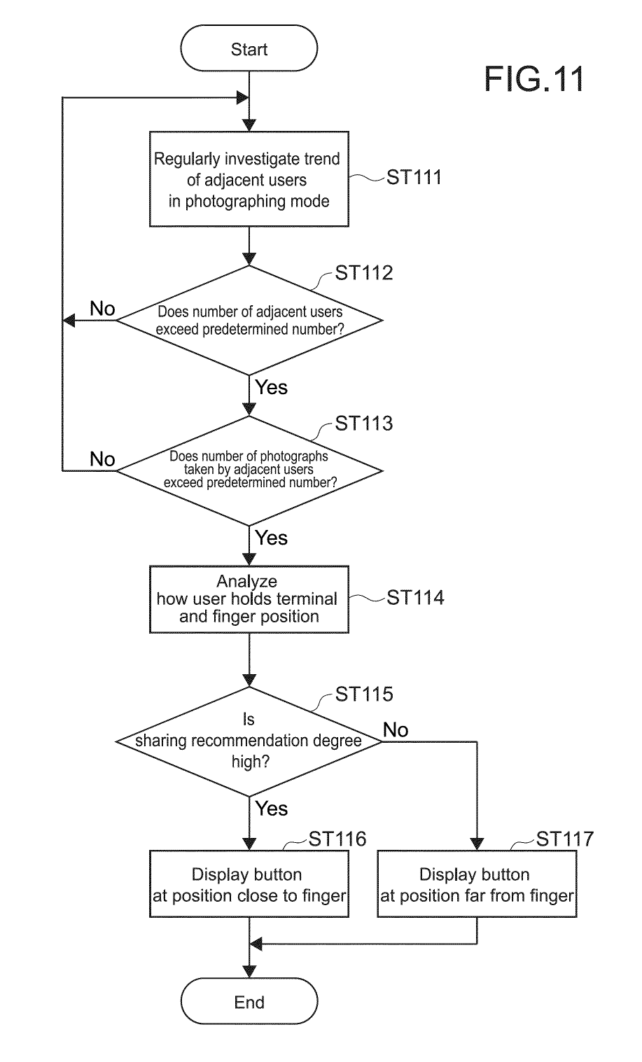

In the above-mentioned examples of FIG. 6, the sharing start button 31 is displayed at a corner of the display 14, and the numbers of adjacent users and sharable photographs, that is, a sharing recommendation degree is expressed by the size of the sharing start button 31. However, the technique of expressing the recommendation degree is not limited thereto. In some embodiments, the one or more processors of portable terminal 100 may be configured to specify a position on the one or more displays of portable terminal 100 at which to display the prompt based at least in part on the calculated sharing recommendation degree. Alternatively or additionally, in some embodiments, the position at which to display the prompt may be specified based at least in part on the estimated position of the user's finger. For example, the portable terminal 100 may change the display position of the sharing start button 31 in accordance with a finger position of the user holding the portable terminal 100. FIG. 11 is a flowchart showing a display processing flow of the sharing start button in this case.

As shown in FIG. 11, the CPU 11 investigates a trend of adjacent devices and determines whether the number of adjacent devices exceeds a predetermined number and whether the number of photographs taken with the adjacent devices exceeds a predetermined number (Steps 111 to 113), as shown in FIG. 2.

When determining in Step 113 that the number of photographs exceeds the predetermined number (Yes), the CPU 11 analyzes how the user is holding the portable terminal 100 and a finger position of the user (Step 114). The analysis is performed using the sensor unit 16 described above. Specifically, the CPU 11 determines which position of the touch panel integrated with the display 14 a finger of the user is touching.

Further, the following cases may be conceived, in which the portable terminal 100 includes a touch sensor also on a rear surface thereof (surface opposite to the surface on which the display 14 is provided), and the portable terminal 100 includes a plurality of other sensors (proximity sensor, pressure-sensitive sensor, illumination sensor, etc.). In such cases, the CPU 11 can determine, based on outputs of those sensors, not only the finger position but also the way of holding the portable terminal 100 by the user, with which of one hand and both hands the portable terminal 100 is held, and the like.

For example, in the case where the user holds the portable terminal 100 with one hand, the CPU 11 determines positions of four fingers of the user with use of the touch sensor provided on its rear surface, to thereby determine how the user is holding the portable terminal 100, and further determine a position of the remaining one finger that may be pressing the touch panel on the front surface. In addition, in the case where the user is holding the portable terminal 100 with both hands, the CPU 11 determines positions of four fingers of the user that support the casing with use of the touch sensor on its rear surface, and generally determines positions of the remaining fingers with use of the touch panel on the front surface and the camera 15. As the number of sensors mounted to the portable terminal 100 increases, the CPU 11 can determine the way of holding the portable terminal 100 with extremely high accuracy.

Subsequently, the CPU 11 determines whether the sharing recommendation degree is high or low, that is, whether the numbers of users of adjacent devices and photographs taken with the adjacent devices are large or not (whether the numbers each exceed a certain number) (Step 115).

When determining that the sharing recommendation degree is high (Yes), the CPU 11 displays the sharing start button 31 in the vicinity of the determined finger position of the user (Step 116), and when determining that the sharing recommendation degree is low (No), the CPU 11 displays the sharing start button 31 at a position spaced away from the finger position of the user (Step 117).

Here, the CPU 11 may not display the sharing start button 31 by binarily determining the sharing recommendation degree, but determine a distance between the finger position of the user and the display position of the sharing start button 31 such that the distance is proportional to the number of users of adjacent devices and the number of photographs.

As the sharing start button 31 is displayed at a position closer to the finger of the user, the user can press the sharing start button 31 more quickly. Therefore, the processing described above is based on the idea that as the sharing recommendation degree becomes higher, the sharing start button 31 should be displayed at a position closer to a finger of a user.

### Modified Example

The present disclosure is not limited to the embodiment described above and may be variously modified without departing from the gist of the present disclosure.

In the embodiment described above, the example has been described in which the number of adjacent users (devices) and the number of photographs taken with those devices are considered as a sharing recommendation degree, and the display form (size and position) of the button is changed in accordance with the sharing recommendation degree. However, the sharing recommendation degree may include various elements in addition to the above. For example, if users of adjacent devices include a user having a close relationship with the user of the portable terminal 100 or a user who takes photographs highly evaluated, the portable terminal 100 may determine that the sharing recommendation degree is high, and then display the sharing start button 31 in a large size or at a position close to the finger of the user. Information on closeness of users or high evaluation can be acquired by analysis of an SNS by the portable terminal 100, for example.

Further, the portable terminal 100 may not increase the sharing recommendation degree in accordance with the number of devices that are present in areas where wireless communication can be performed, but increase the sharing recommendation degree as the number of devices at positions close to the portable terminal 100 becomes larger.

In the embodiment described above, a higher sharing recommendation degree is expressed by the size or position of the sharing start button 31. However, a higher sharing recommendation degree may be expressed by, for example, changing a color, a degree of transparency, a shape, and a motion (animation) of the sharing start button 31.

In the embodiment described above, the sharing start button 31 has been described as a button for directly transmitting and receiving photographs to and from other adjacent devices. However, a button for uploading photographs to a predetermined service such as an SNS, not for directly transmitting and receiving photographs by other adjacent devices, may be displayed in addition to the sharing start button 31 or instead thereof.

In the embodiment described above, the photograph is the content to be shared. However, content other than the photograph, such as a moving image, may be used as content to be shared. Further, various setting items for photographing in the photographing mode may be shared.

In the embodiment described above, a GUI for starting sharing of content is displayed as a button, but GUIs other than the button, such as an icon and a window may be displayed.

At least part of the processing of the portable terminal 100 described in the above embodiment may be executed in a server on the cloud. For example, the server may determine a trend of adjacent devices (the number of devices, the number of taken photographs) and generate the sharing start button 31 to transmit the generated sharing start button 31 to the portable terminal 100. In addition, the server may mediate in transmission and reception processing of content.

(Others)

The present disclosure may also take any of the following configurations.

1. Apparatus comprising: at least one communication interface configured to receive notification of one or more other apparatuses in proximity to the apparatus; and at least one processor configured to, in response to the notification of the one or more other apparatuses in proximity to the apparatus, and based at least in part on a calculated sharing recommendation degree, cause at least one display to display a prompt to share content with at least one of the one or more other apparatuses.

2. The apparatus of configuration 1, wherein the content comprises one or more photographs.

3. The apparatus of configuration 1, wherein the at least one processor is further configured to, in response to a user inputting an affirmative response to the prompt, cause the at least one communication interface to share content with the at least one of the one or more other apparatuses.

4. The apparatus of configuration 3, wherein the prompt comprises a selectable graphical object, and wherein the user inputting an affirmative response to the prompt comprises the user selecting the selectable graphical object.

5. The apparatus of configuration 3, wherein the at least one processor is configured to cause the at least one communication interface to share the content in response to a determination that the at least one of the one or more other apparatuses is in sharing mode.

6. The apparatus of configuration 3, wherein the at least one processor is configured to limit a number of content files shared with the at least one of the one or more other apparatuses.

7. The apparatus of configuration 3, wherein the at least one processor is configured to, in response to the user inputting the affirmative response, cause the at least one communication interface to transmit, for access by the at least one of the one or more other apparatuses, content created by the user after inputting the affirmative response, and not content created by the user before inputting the affirmative response.

8. The apparatus of configuration 3, wherein the at least one processor is configured to, in response to the user inputting the affirmative response, cause the at least one communication interface to receive content transmitted by the at least one of the one or more other apparatuses, and cause the at least one display to display the received content concurrently with content created by the user.

9. The apparatus of configuration 8, wherein the at least one processor is further configured to cause the at least one display to display the received content superimposed on the content created by the user.

10. The apparatus of configuration 8, wherein the at least one processor is configured to specify a position on the at least one display at which to display the received content based at least in part on a location at which the received content was created.

11. The apparatus of configuration 8, wherein the at least one processor is configured to specify a size with which to display the received content based at least in part on a distance between a current position of the apparatus and a location at which the received content was created.

12. The apparatus of configuration 1, wherein the calculated sharing recommendation degree is based at least in part on a number of the one or more other apparatuses in proximity to the apparatus.

13. The apparatus of configuration 1, wherein the calculated sharing recommendation degree is based at least in part on a number of shareable content files available from the one or more other apparatuses.

14. The apparatus of configuration 1, wherein the prompt comprises an indication of the calculated sharing recommendation degree.

15. The apparatus of configuration 1, wherein the prompt comprises an indication of a number of the one or more other apparatuses in proximity to the apparatus and/or an indication of a number of shareable content files available from the one or more other apparatuses.

16. The apparatus of configuration 1, wherein the at least one processor is configured to specify a size of the prompt based at least in part on the calculated sharing recommendation degree.

17. The apparatus of configuration 1, wherein the at least one processor is configured to specify a position on the at least one display at which to display the prompt based at least in part on the calculated sharing recommendation degree.

18. The apparatus of configuration 17, wherein the at least one processor is configured to specify the position based at least in part on an estimated position of a finger of a user of the apparatus.

19. A method comprising: determining that one or more other apparatuses are in proximity to a first apparatus; calculating a sharing recommendation degree; and in response to determining that the one or more other apparatuses are in proximity to the first apparatus, and based at least in part on the calculated sharing recommendation degree, displaying on a display of the first apparatus a prompt to share content with at least one of the one or more other apparatuses.

20. The method of configuration 19, wherein the content comprises one or more photographs.

21. The method of configuration 19, further comprising, in response to a user inputting an affirmative response to the prompt, sharing content with the at least one of the one or more other apparatuses.

22. The method of configuration 21, wherein the prompt comprises a selectable graphical object, and wherein the user inputting an affirmative response to the prompt comprises the user selecting the selectable graphical object.

23. The method of configuration 21, wherein the sharing is performed in response to a determination that the at least one of the one or more other apparatuses is in sharing mode.

24. The method of configuration 21, further comprising limiting a number of content files shared with the at least one of the one or more other apparatuses.

25. The method of configuration 21, wherein the sharing comprises transmitting, for access by the at least one of the one or more other apparatuses, content created by the user after inputting the affirmative response, and not content created by the user before inputting the affirmative response.

26. The method of configuration 21, wherein the sharing comprises receiving content transmitted by the at least one of the one or more other apparatuses, and wherein the method further comprises displaying the received content concurrently with content created by the user.

27. The method of configuration 26, wherein the displaying comprises displaying the received content superimposed on the content created by the user.

28. The method of configuration 26, further comprising specifying a position on the display at which to display the received content based at least in part on a location at which the received content was created.

29. The method of configuration 26, further comprising specifying a size with which to display the received content based at least in part on a distance between a current position of the first apparatus and a location at which the received content was created.

30. The method of configuration 19, wherein the calculated sharing recommendation degree is based at least in part on a number of the one or more other apparatuses in proximity to the first apparatus.

31. The method of configuration 19, wherein the calculated sharing recommendation degree is based at least in part on a number of shareable content files available from the one or more other apparatuses.

32. The method of configuration 19, wherein the prompt comprises an indication of the calculated sharing recommendation degree.

33. The method of configuration 19, wherein the prompt comprises an indication of a number of the one or more other apparatuses in proximity to the first apparatus and/or an indication of a number of shareable content files available from the one or more other apparatuses.

34. The method of configuration 19, further comprising specifying a size of the prompt based at least in part on the calculated sharing recommendation degree.

35. The method of configuration 19, further comprising specifying a position on the display at which to display the prompt based at least in part on the calculated sharing recommendation degree.

36. The method of configuration 35, wherein the position is specified based at least in part on an estimated position of a finger of a user of the apparatus.

37. At least one computer-readable storage medium encoded with computer-executable instructions that, when executed, perform a method comprising: determining that one or more other apparatuses are in proximity to a first apparatus; calculating a sharing recommendation degree; and in response to determining that the one or more other apparatuses are in proximity to the first apparatus, and based at least in part on the calculated sharing recommendation degree, displaying on a display of the first apparatus a prompt to share content with at least one of the one or more other apparatuses.

38. The at least one computer-readable storage medium of configuration 37, wherein the content comprises one or more photographs.

39. The at least one computer-readable storage medium of configuration 37, wherein the method further comprises, in response to a user inputting an affirmative response to the prompt, sharing content with the at least one of the one or more other apparatuses.

40. The at least one computer-readable storage medium of configuration 39, wherein the prompt comprises a selectable graphical object, and wherein the user inputting an affirmative response to the prompt comprises the user selecting the selectable graphical object.

41. The at least one computer-readable storage medium of configuration 39, wherein the sharing is performed in response to a determination that the at least one of the one or more other apparatuses is in sharing mode.

42. The at least one computer-readable storage medium of configuration 39, wherein the method further comprises limiting a number of content files shared with the at least one of the one or more other apparatuses.

43. The at least one computer-readable storage medium of configuration 39, wherein the sharing comprises transmitting, for access by the at least one of the one or more other apparatuses, content created by the user after inputting the affirmative response, and not content created by the user before inputting the affirmative response.

44. The at least one computer-readable storage medium of configuration 39, wherein the sharing comprises receiving content transmitted by the at least one of the one or more other apparatuses, and wherein the method further comprises displaying the received content concurrently with content created by the user.

45. The at least one computer-readable storage medium of configuration 44, wherein the displaying comprises displaying the received content superimposed on the content created by the user.

46. The at least one computer-readable storage medium of configuration 44, wherein the method further comprises specifying a position on the display at which to display the received content based at least in part on a location at which the received content was created.

47. The at least one computer-readable storage medium of configuration 44, wherein the method further comprises specifying a size with which to display the received content based at least in part on a distance between a current position of the first apparatus and a location at which the received content was created.

48. The at least one computer-readable storage medium of configuration 37, wherein the calculated sharing recommendation degree is based at least in part on a number of the one or more other apparatuses in proximity to the first apparatus.

49. The at least one computer-readable storage medium of configuration 37, wherein the calculated sharing recommendation degree is based at least in part on a number of shareable content files available from the one or more other apparatuses.

50. The at least one computer-readable storage medium of configuration 37, wherein the prompt comprises an indication of the calculated sharing recommendation degree.

51. The at least one computer-readable storage medium of configuration 37, wherein the prompt comprises an indication of a number of the one or more other apparatuses in proximity to the first apparatus and/or an indication of a number of shareable content files available from the one or more other apparatuses.

52. The at least one computer-readable storage medium of configuration 37, wherein the method further comprises specifying a size of the prompt based at least in part on the calculated sharing recommendation degree.

53. The at least one computer-readable storage medium of configuration 37, wherein the method further comprises specifying a position on the display at which to display the prompt based at least in part on the calculated sharing recommendation degree.

54. The at least one computer-readable storage medium of configuration 53, wherein the position is specified based at least in part on an estimated position of a finger of a user of the apparatus.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., a tangible, non-transitory computer-readable medium, such as a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein.

In addition, it should be appreciated that the reference to a computer program which, when executed, performs any of the above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. Apparatus comprising:
at least one communication interface configured to receive notification of one or more other apparatuses in proximity to the apparatus; and
at least one processor configured to, in response to the notification of the one or more other apparatuses in proximity to the apparatus, and based at least in part on a calculated sharing recommendation degree, cause at least one display to display a prompt to share content with at least one of the one or more other apparatuses.

2. The apparatus of claim 1, wherein the content comprises one or more photographs.

3. The apparatus of claim 1, wherein the at least one processor is further configured to, in response to a user inputting an affirmative response to the prompt, cause the at least one communication interface to share content with the at least one of the one or more other apparatuses.

4. The apparatus of claim 3, wherein the prompt comprises a selectable graphical object, and wherein the user inputting an affirmative response to the prompt comprises the user selecting the selectable graphical object.

5. The apparatus of claim 3, wherein the at least one processor is configured to cause the at least one communication interface to share the content in response to a determination that the at least one of the one or more other apparatuses is in sharing mode.

6. The apparatus of claim 3, wherein the at least one processor is configured to limit a number of content files shared with the at least one of the one or more other apparatuses.

7. The apparatus of claim 3, wherein the at least one processor is configured to, in response to the user inputting the affirmative response, cause the at least one communication interface to transmit, for access by the at least one of the one or more other apparatuses, content created by the user after inputting the affirmative response, and not content created by the user before inputting the affirmative response.

8. The apparatus of claim 3, wherein the at least one processor is configured to, in response to the user inputting the affirmative response, cause the at least one communication interface to receive content transmitted by the at least one of the one or more other apparatuses, and cause the at least one display to display the received content concurrently with content created by the user.

9. The apparatus of claim 8, wherein the at least one processor is further configured to cause the at least one display to display the received content superimposed on the content created by the user.

10. The apparatus of claim 8, wherein the at least one processor is configured to specify a position on the at least one display at which to display the received content based at least in part on a location at which the received content was created.

11. The apparatus of claim 8, wherein the at least one processor is configured to specify a size with which to display the received content based at least in part on a distance between a current position of the apparatus and a location at which the received content was created.

12. The apparatus of claim 1, wherein the calculated sharing recommendation degree is based at least in part on a number of the one or more other apparatuses in proximity to the apparatus.

13. The apparatus of claim 1, wherein the calculated sharing recommendation degree is based at least in part on a number of shareable content files available from the one or more other apparatuses.

14. The apparatus of claim 1, wherein the prompt comprises an indication of the calculated sharing recommendation degree.

15. The apparatus of claim 1, wherein the prompt comprises an indication of a number of the one or more other apparatuses in proximity to the apparatus and/or an indication of a number of shareable content files available from the one or more other apparatuses.

16. The apparatus of claim 1, wherein the at least one processor is configured to specify a size of the prompt based at least in part on the calculated sharing recommendation degree.

17. The apparatus of claim 1, wherein the at least one processor is configured to specify a position on the at least one display at which to display the prompt based at least in part on the calculated sharing recommendation degree.

18. The apparatus of claim 17, wherein the at least one processor is configured to specify the position based at least in part on an estimated position of a finger of a user of the apparatus.

19. A method comprising:
determining that one or more other apparatuses are in proximity to a first apparatus;
calculating a sharing recommendation degree; and
in response to determining that the one or more other apparatuses are in proximity to the first apparatus, and based at least in part on the calculated sharing recommendation degree, displaying on a display of the first apparatus a prompt to share content with at least one of the one or more other apparatuses.

20. At least one computer-readable storage medium encoded with computer-executable instructions that, when executed, perform a method comprising:
determining that one or more other apparatuses are in proximity to a first apparatus;
calculating a sharing recommendation degree; and
in response to determining that the one or more other apparatuses are in proximity to the first apparatus, and based at least in part on the calculated sharing recommendation degree, displaying on a display of the first apparatus a prompt to share content with at least one of the one or more other apparatuses.
